(19) United States
(12) Patent Application Publication
(10) Pub. No.: US 2025/0279012 A1
(43) Pub. Date: Sep. 4, 2025

(54) METHOD FOR PROVIDING A USER TUTORIAL FOR A VEHICLE AND A VEHICLE PROVIDING THE USER TUTORIAL

(71) Applicants: Hyundai Motor Company, Seoul (KR); Kia Corporation, Seoul (KR)

(72) Inventor: Young Hoon Kim, Hwaseong-si (KR)

(21) Appl. No.: 18/934,730

(22) Filed: Nov. 1, 2024

(30) Foreign Application Priority Data
Mar. 4, 2024 (KR) 10-2024-0030566

(51) Int. Cl. G09B 19/16; B60W 50/14; G06F 8/61; G06Q 30/0601

(52) U.S. Cl. CPC G09B 19/167; B60W 50/14; G06F 8/61; B60W 2050/146; G06Q 30/0641

(57) ABSTRACT

A method for providing a user tutorial of a plurality of driving assistance functions in a vehicle including a sensor module and a controller for identifying a driving situation based on sensor information received from the sensor module, can include the controller identifying whether a preset event occurs during driving of the vehicle, and the controller creating a tutorial file for the event according to occurrence of the event. The tutorial event can be displayed to the driver after the driving is terminated to provide the user tutorial to the driver.

### CROSS-REFERENCE TO RELATED APPLICATIONS

This application claims the priority and benefit of Korean Patent Application No. 10-2024-0030566, filed on Mar. 4, 2024, which application is hereby incorporated herein by reference.

### TECHNICAL FIELD

The present disclosure relates to providing a user tutorial for a vehicle.

### BACKGROUND

As functions that assist a driver to control a vehicle increase and become more advanced, the complexity of using the functions is increasing.

Many drivers have difficulty using such complex functions, in particular, as drivers become older and technology becomes more advanced, more drivers experience the difficulty.

Therefore, from vehicle manufacturers' perspectives, there is a need to inform drivers of the technologies applied to the vehicle and the benefits of such functions in terms of fuel efficiency, safety, convenience, etc.

### SUMMARY

The present disclosure relates to a method for providing a user tutorial for a vehicle and a vehicle providing the user tutorial.

An embodiment of the present disclosure can efficiently inform drivers of vehicle functions.

An embodiment of the present disclosure can provide a tutorial of vehicle functions through virtual driving scenes that reconstruct events based on the driving record of the driver.

An embodiment of the present disclosure can provide a method for providing a user tutorial of a plurality of driving assistance functions in a vehicle, and the method can include determining, by a controller, a driving situation based on sensor information received from a sensor module, determining, by the controller, an occurrence of a preset event while the vehicle drives, and creating, by the controller, a tutorial file for the preset event.

The tutorial file may include the sensor information during a preset driving interval before and after a time point of the occurrence of the preset event.

The sensor information may include a camera image, and at least one of a speed of the vehicle, a distance from a surrounding vehicle, or collision risk information with the surrounding vehicle, or any combination thereof.

The tutorial file may include usage simulation details for at least one function of the plurality of driving assistance functions.

The tutorial file may further include usage guidance on a user input corresponding to the at least one function.

The tutorial file may further include inquiring a purchasing status for the at least one function or transmitting a purchasing decision for the at least one function to a server.

The method may further include downloading and installing, by the controller, a computer program for the at least one function from the server.

The method may further include transmitting the tutorial file to a display device in the vehicle.

The transmitting the tutorial file to the display device may include displaying, by the display device, the tutorial file on a screen after the driving is terminated.

The method may include transmitting the tutorial file to a server.

An embodiment of the present disclosure can provide a vehicle, and the vehicle can include a sensor module, and a controller including a memory for storing a computer program and a processor configured to execute the computer program, where the controller is configured, by the processor executing the computer program, to determine a driving situation based on sensor information received from the sensor module, determine an occurrence of a preset event while the vehicle drives, and create a tutorial file for the preset event.

The tutorial file may include the sensor information during a preset driving interval before and after a time point of occurrence of the preset event.

The sensor information may include a camera image, and one of a speed of the vehicle, a distance from a surrounding vehicle, or collision risk information with the surrounding vehicle, or any combination thereof.

The tutorial file may include usage simulation details of at least one function of the plurality of driving assistance functions.

The tutorial file may further include usage guidance on a user input corresponding to the at least one function.

The tutorial file may further include inquiring a purchasing status for the at least one function or transmitting a purchasing decision for the at least one function to a server.

The controller may be further configured to download and install a computer program for the at least one function from the server.

The controller may be further configured to transmit the tutorial file to a display device in the vehicle.

The display device may be configured to output the tutorial file to a screen after the driving is terminated.

The controller may be further configured to transmit the tutorial file to the server.

An embodiment of the present disclosure is provided to efficiently inform drivers of vehicle functions.

An embodiment of the present disclosure can provide a tutorial of vehicle functions through virtual driving scenes that reconstruct events based on the driving record of the driver, that is, a tutorial based on user experience, thereby providing efficient guidance on the functions.

### BRIEF DESCRIPTION OF THE DRAWINGS

FIG. 1 is a schematic view illustrating a system according to an embodiment of the present disclosure;

FIG. 2 is a view illustrating a tutorial providing process according to an embodiment of the present disclosure;

FIG. 3A, FIG. 3B, FIG. 3C, and FIG. 3D are example views illustrating that a tutorial is created and replayed according to an embodiment of the present disclosure;

FIG. 4 is an example view illustrating part of a tutorial according to an embodiment of the present disclosure; and

FIG. 5 is a view illustrating a process of purchasing vehicle functions according to an embodiment of the present disclosure.

### DETAILED DESCRIPTION OF ILLUSTRATIVE EMBODIMENTS

While example embodiments are described with reference to the accompanying drawings, it can be understood that various changes and modifications may be made in other embodiments of the present disclosure. Further, it can be understood that the present disclosure is not necessarily limited to the specific example embodiments thereof, and various changes, equivalences, and substitutions may be made without departing from the scopes and spirit of the present disclosure.

In the example embodiments of the present disclosure, terms such as “module”, “unit”, “part”, and the like, can be used for nominal distinct between components, and should not necessarily be interpreted as assuming that they are physically and chemically separated or capable of being separated or divided.

Terms containing ordinal numbers, such as “first”, “second”, etc., may be used to describe various components, but such components are not necessarily limited by such terms. Such terms may be used only in a nominal sense to differentiate one component from another component, and their mutual sequential meaning can be understood through the context of the corresponding description.

The term “and/or” can be used to include all instances of any combination of multiple items being the subject. For example, “A and/or B” includes all three cases: “A”, “B”, and “A and B”.

When a component is used to be “coupled” or “connected” to another component, it can be understood that the component may be either connected directly to another component, or connected indirectly via another medium and/or intervening component(s).

Terms in the present application can be used to describe an example embodiment and do not intend to necessarily restrict and/or limit the present disclosure. Singular forms can be intended to include plural forms unless the context clearly indicates otherwise. According to an embodiment of the present disclosure, terms such as “comprise” or “consist of” are used to designate presence of characteristics, numbers, steps, operations, elements, components, or a combination thereof, and do not foreclose the presence or possibility of addition of one or more other characteristics, numbers, steps, operations, elements, components, or a combination thereof.

Unless otherwise defined, terms used in the present disclosure, including technical or scientific terms, can have a same meaning as generally understood by an ordinary person skilled in the technical field to which the present disclosure pertains. Terms defined in commonly used dictionaries can be interpreted as having a meaning consistent with the meaning in the context of the related technology, and unless clearly defined in this application, should not be interpreted in an ideal or excessively formal sense.

In addition, the terms “unit”, “control unit”, “control device”, or “controller” can be widely used for names of devices that control the corresponding functions, and are not construed as being generic functional units. For example, devices using such terms may include a communication device that communicates with another controller or sensor to control the corresponding function, a computer-readable recording media that stores operating systems, logic commands, input/output information, etc., and at least one or more of processor that performs determination, calculation, decision, etc. used to control the corresponding function.

A processor may include a semiconductor integrated circuit and/or electronic elements that perform at least one or more of comparison, determination, calculation, and decision to achieve a programmed function. For example, a processor may be one or the combination of a computer, a microprocessor, a CPU, an ASIC, and electronic circuits (circuitry, logic circuits).

A computer-readable recording medium (or referred to as memory or storage medium) can include all types of storage devices that store data that is read by a computer system. Examples of the computer-readable recording medium may include a memory of flash memory type, hard disk type, micro type, and card type (e.g. Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, or an optical disk type, or any combination thereof.

The recording medium may be electrically connected to the processor, and the processor may load and record data from the recording medium. The recording medium and the processor may be integrated or physically separated.

Example embodiments of the present disclosure will be detailed with reference to the drawings below.

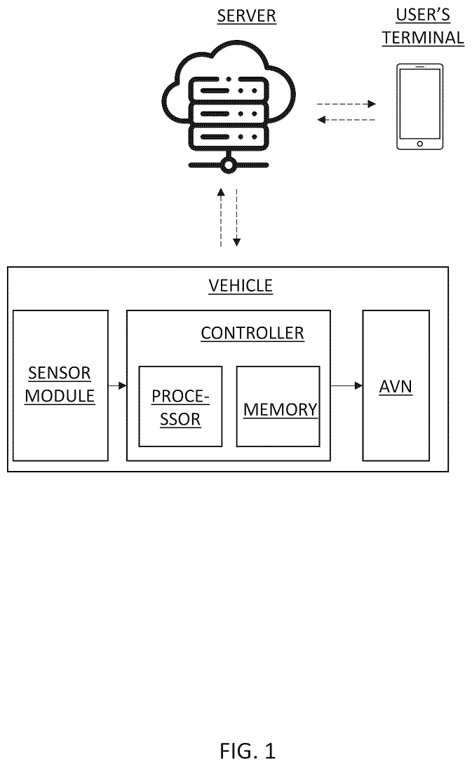

Referring to FIG. 1, a vehicle according to an embodiment of the present disclosure may include a sensor module, a controller, and an Audio Video Navigation (AVN) as a display device.

Although not shown, a vehicle according to an embodiment may include a communication module through which the vehicle communicates with a user terminal and/or a server.

The vehicle may be capable of wireless mobile communication, wireless internet communication, or short-distance communication through a communication module.

Wireless mobile communication may include at least one of Global System for Mobile communication (GSM), Code Division Multi Access (CDMA), Wideband CDMA (WCDMA), High Speed Downlink Packet Access (HSDPA), Long Term Evolution (LTE), 5G, etc.

Wireless internet communication may include at least one of Wireless LAN (WLAN), Wireless Fidelity (WiFi), Digital Living Network Alliance (DLNA), Wireless broadband (Wibro), and World Interoperability for Microwave Access (Wimax).

Short-distance communication may include at least one of Bluetooth, Radio Frequency Identification (RFID), Infrared Data Association (IrDA), Ultra-Wideband (UWB), ZigBee, Near Field Communication (NFC), and Wireless-Fidelity (Wi-Fi) Direct technology.

A sensor module may include at least one or more of at least one lidar sensor, at least one radar sensor, or at least one camera, or any combination thereof, through which surrounding situations of a vehicle can be monitored while driving.

The sensor module may include one or more of a speed sensor, an acceleration sensor, a location sensor (e.g., a GPS receiver), a steering angle sensor, an accelerator pedal sensor, or a brake pedal sensor, or any combination thereof, through which the vehicle status or control condition by a driver can be detected.

The sensor module may include a camera, a touch sensor, etc. for monitoring a driver while driving. For example, the sensor module may include a camera for identifying whether the driver is drowsy or negligent in looking ahead by monitoring the eyes of the driver, and a detection sensor for detecting whether the hands of the driver leave from the steering wheel.

A vehicle according to an embodiment may include driving assistance functions to assist a driver in controlling a vehicle related to one or more of fuel-efficiency, safety, convenience, etc.

Each driving assistance function may be implemented by hardware such as an actuator for the function and a computer program for logic to implement the function.

Driving assistance function may include, by way of example, at least one of a vehicle control function for improving fuel efficiency, automatic steering avoidance or automatic braking to prevent collision with front or rear obstacles, blind spot obstacle detection, lane line departure prevention, lane line maintenance, cruise automatic driving, parking assistance, ramp control assistance, or slope driving assistance, or any combination thereof.

By way of example, the driving assistance function to improve fuel efficiency may include at least one of a sudden acceleration suppression function, a sudden braking suppression function, or a vehicle speed limit function to improve fuel efficiency, or any combination thereof.

The driving assistance function may be an Advanced Driver Assistance System (ADAS) function, including at least one of Smart Cruise Control (SCC), Adaptive Cruise Control (ASCC), Lane Departure Warning System (LDWS), Lane Keeping Assist System (LKAS), Forward Collision Warning (FCW), tonomous Emergency Brake (AEB), Blind-spot Collision Warning (BSCW), Smart Parking Assist System (SPAS), Remote Smart Parking Assist (RSPA), Rear Cross Traffic Alert (RCTA), Adaptive Headlamp (AH), Adaptive Driving Beam (ADB), or Hill Start Assist Control System (HSACS), or any combination thereof, for example.

According to an embodiment, a controller may include a computer processor and a memory described above.

A memory may store a computer program for generating a user tutorial for a driving assistance function, and a processor may read the program from the memory for execution.

A controller may identify a driving situation based on sensor information received from the sensor module through program execution by the processor, and create the corresponding tutorial according to the occurrence of an event.

A controller may identify a driving situation based on sensor information received from the sensor module through program execution by the processor, and create the corresponding tutorial according to the occurrence of an event.

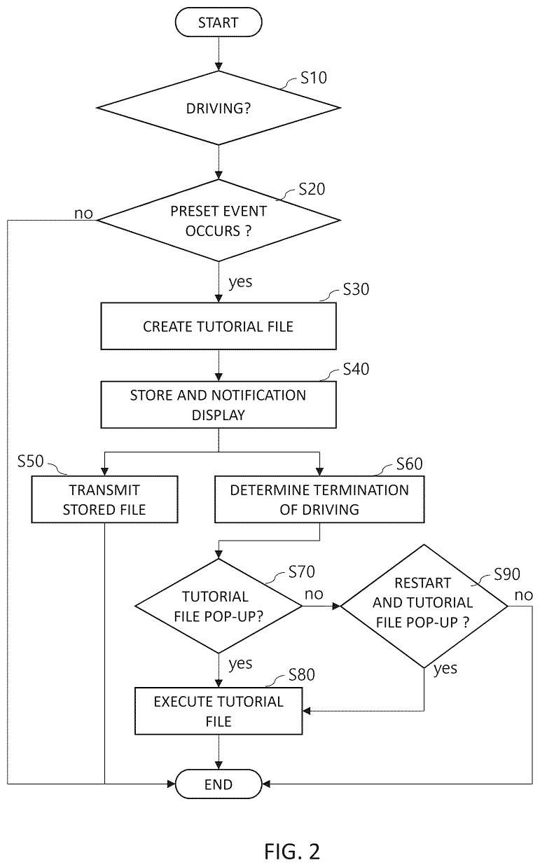

Referring to FIG. 2, a tutorial creation and execution process according to an embodiment of the present disclosure will be described below.

At operation S10, the controller may determine whether a vehicle is driving.

At operation S20, it may be determined whether an event has occurred according to the preset conditions.

For example, when the situation is assessed as a risk of collision according to a collision risk assessment with the vehicle ahead, it may be determined that a collision risk event occurs.

For example, when an obstacle is detected in a blind spot of the next driving lane line, and the steering wheel operation of the driver is detected to change its lane line to the next driving lane line, it may be determined that a lane line change risk event occurs.

For example, when times the accelerator pedal is pressed or the sum of the distances the accelerator pedal is pressed while driving exceeds a preset value, or when rapid acceleration or deceleration occurs while driving, the controller may determine that a low fuel efficiency driving event occurs.

When drowsy driving is confirmed through a driver monitoring camera while driving, a controller may determine that a drowsy driving event occurs.

At operation S20, when it is determined that a preset event occurs, the controller may create a tutorial file corresponding to the event at operation S30.

The tutorial file may include sensor information of a sensor module for a preset driving interval before and after the occurrence of the event.

The sensor information may include a camera image, including at least one of the speed of the vehicle, distances from surrounding vehicles, and information on a risk of collision with surrounding vehicles.

The tutorial file may include images or video files of virtual driving situation scenes generated based on the sensor information.

The controller may determine the driving assistance function corresponding to the event and include the usage simulation details of the function in the tutorial file.

The tutorial file may further include guidance on a user input unit for the function. The tutorial file may include the guidance of the location of a user selection button and an operation method thereof to activate the function.

As it is confirmed that the function is not equipped with the vehicle, the controller may add transmitting a purchasing intention inquiry of the function and a user purchasing decision to a server.

When the tutorial file is created, the controller may store the file and output a notification to the driver at operation S40.

For example, the controller may output a notification message that the tutorial file is created to a cluster or an AVN screen.

At operation S50, the controller may transmit the tutorial file to the server.

Referring to FIG. 1, the user may replay and identify the tutorial file stored in the server through a user terminal.

The server may provide a dedicated program, and the user may download and install the program in the user terminal.

The user terminal may be a desktop computer, a tablet computer, a smartphone, or a smartwatch, for example.

The controller may transmit the tutorial file to the AVN at operation S50.

The received tutorial file may be stored in the memory of the AVN, and a dedicated folder may be created and managed.

The controller may confirm that the vehicle operation is terminated at operation S60.

For example, it may be determined that the operation is terminated when the notification is received that the vehicle reaches a destination from the AVN, or when the engine of the vehicle is turned off.

Although the operation is terminated due to the turn-off, the controller may maintain the power as an on-state at operation S70.

When the operation is terminated, as a default setting, the AVN may pop up the tutorial file, and inquire a user selection whether to execute the file.

The controller or the AVN, when the tutorial file pops up, and the user selection for the execution is input at operation S70, may execute the file at operation S80.

When the tutorial file fails to pop up at operation S70, the vehicle may restart and the tutorial file may be popped up at operation S90.

When the execution selection of the user is input at operation S90, the file may be executed at operation S80.

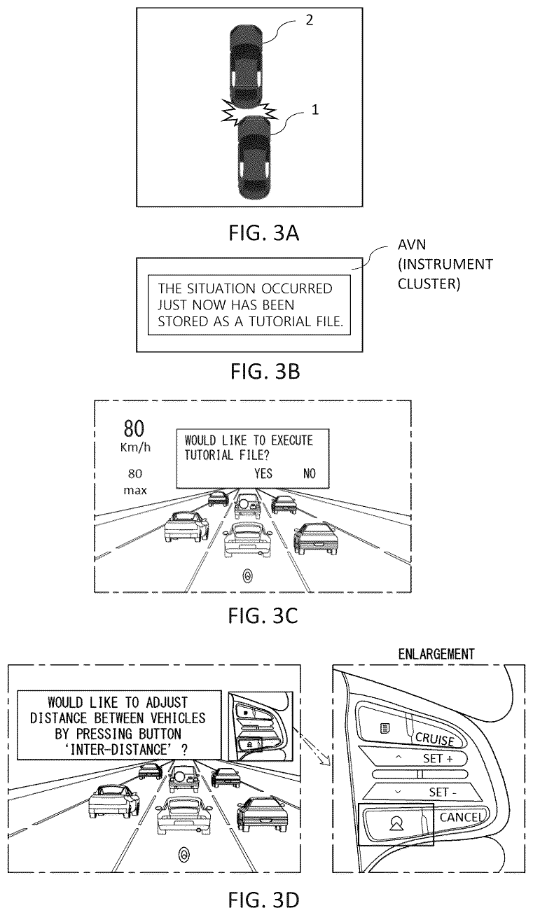

FIGS. 3A to 3D are example views illustrating that a tutorial file is created and executed, and the detailed description thereof will be made below.

FIG. 3A is an example view illustrating that a collision risk event with an ahead vehicle 2 occurs while a vehicle 1 is driving.

For example, according to the preset conditions, the possibility of collision with the ahead vehicle 2 may be evaluated based on the relative distance and relative speed with the ahead vehicle 2, and when it is determined that there is a risk of collision accordingly, the controller may determine that the event occurs.

Referring to FIG. 3A, according to the event, the controller may create a tutorial file, and output a message informing that the file is created and stored as shown in FIG. 3B, to an AVN screen (or a cluster).

The file may be executed through the AVN screen or through the user terminal by receiving the file from the server when the operation is terminated.

Referring to FIG. 3C, the file may be popped up on the AVN screen or the user terminal, and an inquiry message about whether to execute the file, and a pop-up message screen to receive user selection may be displayed.

Referring to FIG. 3C, a user may select ‘YES’, and the file may be replayed and displayed on the screen.

FIG. 3D illustrates an example of replay, and as shown in FIG. 3D, the file may include an image or a video of the event-related driving situation. The image or video may include a camera image or a video received from the sensor module, or a virtual image or video implemented with or without a camera live image or video.

FIG. 3D illustrates the simulation details of an ‘inter-vehicle distance’ function (e.g., a function that assists a vehicle control to maintain the distance from the vehicle ahead by setting the distance from the vehicle) as a driving assistance function determined by the controller as the event-related).

As shown in FIG. 3D, the tutorial file may include the simulation details and guidance on the user input unit for the corresponding function.

As an example, in the upper right end of FIG. 3D, an image showing the location of the corresponding function button in the vehicle is displayed with enlargement and highlighting a relevant function button.

Referring to FIG. 3D, the simulation details may include a video in which an event occurrence situation is replayed while the corresponding function is activated as the corresponding button shown in FIG. 3D is pressed.

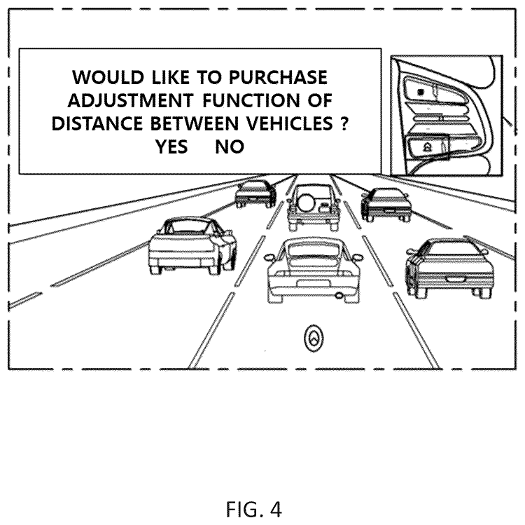

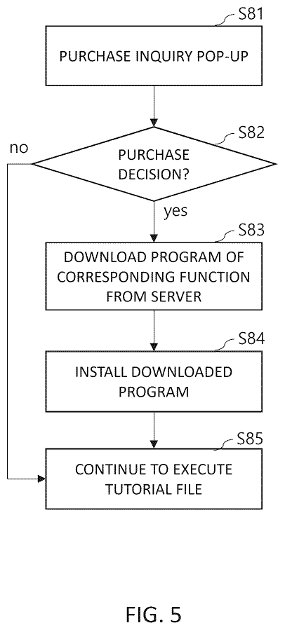

When it is determined that the driving assistance function related to the event is not provided in the vehicle, the controller may include a pop-up screen inquiring whether to purchase the function as shown in FIG. 4 of the simulation details. The detailed description thereof will be made with reference to FIG. 5.

FIG. 5 illustrates that the purchasing inquiry pop-up screen as shown in FIG. 4 is displayed at operation S81.

When the user decides to purchase at operation S82, which can be selecting ‘YES’ in the purchasing inquiry pop-up screen, for example, the controller or the AVN (or a user terminal) may transmit the decision to the server.

The server may transmit the computer program of the corresponding function according to the purchasing decision, and the controller or the AVN may download the transmitted program at operation S83.

The controller or the AVN may install the program downloaded in the vehicle at operation S84.

The controller or the AVN may continue to execute the tutorial file at operation S85.

Examples of the event related to fuel efficiency and the event related to drowsy driving will be described below.

For example, when the driver pushes an accelerator pedal hard while driving and the controller determines that a fuel efficiency-related event occurs, a tutorial file related to the event may be created and stored.

The tutorial file may include the simulation details for a ‘fuel-efficiency mode’ function (e.g., a driver assistance function to achieve high fuel efficiency) and the details related to its purchase.

As an example, when it is determined that a drowsy driving situation occurs by the driver monitoring camera, the controller may create and store a related tutorial.

The tutorial file may include the simulation details for a ‘shoulder guidance’ function (e.g., a function that automatically guides the vehicle to the shoulder and stops during drowsy driving) and the details related to its purchase.

What is claimed is:

1. A method for providing a user tutorial of a plurality of driving assistance functions in a vehicle, the method comprising:
determining a driving situation based on sensor information received from a sensor module;
determining an occurrence of a preset event while the vehicle drives; and
creating a tutorial file for the preset event.

2. The method as claimed in claim 1, wherein the tutorial file includes the sensor information during a preset driving interval before and after a time point of the occurrence of the preset event.

3. The method as claimed in claim 2, wherein the sensor information includes a camera image, and wherein the sensor information includes a speed of the vehicle, a distance from a surrounding vehicle, collision risk information regarding a collision risk with the surrounding vehicle, or any combination thereof.

4. The method as claimed in claim 1, wherein the tutorial file includes usage simulation details for at least one function of the plurality of driving assistance functions.

5. The method as claimed in claim 4, wherein the tutorial file further includes usage guidance on a user input corresponding to the at least one function.

6. The method as claimed in claim 4, wherein the tutorial file further includes an inquiry for purchasing of the at least one function, and wherein the method further comprises transmitting a purchasing decision for the at least one function to a server.

7. The method as claimed in claim 6, further comprising downloading and installing a computer program for the at least one function from the server.

8. A method for providing a user tutorial of a plurality of driving assistance functions in a vehicle, the method comprising:
determining a driving situation based on sensor information received from a sensor module;
determining an occurrence of a preset event while the vehicle drives;
creating a tutorial file for the preset event; and
transmitting the tutorial file to a display device in the vehicle.

9. The method as claimed in claim 8, further comprising displaying the tutorial file on a screen in the vehicle after driving of the vehicle is terminated.

10. The method as claimed in claim 1, further comprising transmitting the tutorial file to a server.

11. A vehicle comprising:
a sensor module; and
a controller comprising at least one processor and a memory storing computer-readable instructions that, when executed by the at least one processor, enable the at least one processor to:
determine a driving situation based on sensor information received from the sensor module,
determine an occurrence of a preset event while the vehicle drives, and
create a tutorial file for the preset event.

12. The vehicle as claimed in claim 11, wherein the tutorial file includes the sensor information during a preset driving interval before and after a time point of occurrence of the preset event.

13. The vehicle as claimed in claim 12, wherein the sensor information includes a camera image, and wherein the sensor information includes a speed of the vehicle, a distance from a surrounding vehicle, collision risk information with the surrounding vehicle, or any combination thereof.

14. The vehicle as claimed in claim 11, wherein the tutorial file includes usage simulation details of at least one function of a plurality of driving assistance functions.

15. The vehicle as claimed in claim 14, wherein the tutorial file further includes usage guidance on a user input corresponding to the at least one function.

16. The vehicle as claimed in claim 14, wherein the tutorial file further includes an inquiry for purchasing the at least one function, and wherein the instructions further enable the at least one processor to transmit a purchasing decision for the at least one function to a server.

17. The vehicle as claimed in claim 16, wherein the instructions further enable the at least one processor to download and install a computer program for the at least one function from the server.

18. The vehicle as claimed in claim 11, wherein the instructions further enable the at least one processor to transmit the tutorial file to a display device in the vehicle.

19. The vehicle as claimed in claim 18, wherein the display device is configured to output the tutorial file to a screen after driving of the vehicle is terminated.

20. The vehicle as claimed in claim 11, wherein the instructions further enable the at least one processor to transmit the tutorial file to a server.
